(19) United States
(12) Patent Application Publication
(10) Pub. No.: US 2025/0223869 A1
(43) Pub. Date: Jul. 10, 2025

(54) Stackable, Mono- and Biofocal Slats for Deflecting Light

(71) Applicant: Helmut Koester, Frankfurt (DE)

(72) Inventor: Helmut Koester, Frankfurt (DE)

(21) Appl. No.: 17/609,297

(22) PCT Filed: May 5, 2020
(86) PCT No.: PCT/EP2020/062475

§ 371 Date: May 8, 2022

(30) Foreign Application Priority Data
May 6, 2019 (DE) 10 2019 206 495.3
May 6, 2019 (DE) 10 2019 206 497.3
May 27, 2019 (DE) 10 2019 207 768.4

(51) Int. Cl. E06B 9/386; E06B 9/24

(52) U.S. Cl. CPC E06B 9/386; E06B 2009/2417; E06B 2009/2482

(57) ABSTRACT

The invention relates to stackable slats for directing light as a preliminary product for blind sun protection hangings for directing light: the slats are folded in the longitudinal direction and have a lateral light shadow side and a lateral light irradiation side vis-à-vis lateral light from the upper half-space. At least two slats lying one on top of another have at least partly a fold-shaped contour zone K, in which the slats are able to be placed one on top of another shape-complementarily, and also at least one edge zone RZ. An upper slat lying on a bottom slat in the installation state at least in an edge zone RZ on the lateral light incidence side has at least one larger fold angle 3 and/or 4 relative to the contour zone K. At least one edge zone RZ of a top slat is shaped differently from an edge zone RZ of a bottom slat. With the slat preliminary products bifocal blind sun protection hangings are producible, by means of which in the lower hanging region through the bottom slats lateral light is able to be reflected back substantially into the half-space of the light incidence and in the upper region of the blind sun protection hanging through the overlying slats lateral light with high angles of incidence from the sun is able to be reflected at least partly into the half-space opposite the lateral light incidence. Lateral light incidence is able to be reflected back into the half-space of the light incidence by way of the shape-complementary contour zone K.

### FIELD OF THE INVENTION

The invention relates to stackable, light-directing slats as a preliminary product for light directing blind hangings which consist of slats having metallic reflector lustre at least at the top side thereof, wherein the slats are at least partly folded in the longitudinal direction. In each case one fold side faces the incident lateral light and a further fold side faces away relative to the lateral light. Two slats lying one above another at least partly have an approximately shape-complementary core zone K and a differently shaped edge zone RZ.

### BACKGROUND OF THE INVENTION

DE19828542. A1 discloses configuring one slat half such that it directs light in and a second slat half, located towards the incidence of radiation, such that it directs light out. Zenith light is masked out, however. This applies to slats in accordance with FIG. 11, too, because sunlight <90° is not deflected into the interior but rather onto a retroreflective segment. In order to be able to obtain the zenith light as well, PCT/EP2017/052175 proposes incorporating the slats in the skylight in a manner rotated 180° about a vertical axis. Here there is then the risk that such slats offset relative to one another will not fit together cleanly if they are intended to be deployed in a slat assembly as blinds. Moreover, the slat cross sections are asymmetrical and they can easily warp during production on account of an asymmetrical stress distribution over the cross section and distort upon the action of heat as a result of insolation in the course of the service life. A further disadvantage is that the segments that direct light in can produce glare in the breast region when the directing-in reflector is looked at. Moreover, an excessively high energy input results when there is shallow light incidence in summer.

### OBJECTS AND SUMMARY OF THE INVENTION

The object of the innovation, therefore, is to develop stackable slat structures for bifocal slat hangings which direct in zenith light without the interiors being overheated as a result of excessively high transmission. Furthermore, it is necessary to develop cross sections that are approximately symmetrical in the contour configuration in order to uniformly distribute the material stresses in the production process and in the end product. The slats in the lower window region must be free of glare and the slats in the lower and upper window regions within a hanging should be able to fit together in a positively locking manner to form a slat assembly.

The objects are achieved in accordance with the characterizing part of the main claim.

The advantage of the innovation is a common retro-reflective basic structure of the slats in the lower and upper window regions, which reflect incident lateral light—that is to say the sun—back into the sky in the installed state of a sun protection blind. Only the edge zone RZ of the slats towards the light incidence side and towards the opposite slat side—that is to say towards the interior side—are configured in a variable fashion. In the upper hanging region, they are designed to deflect light into the half-space opposite the sunlight incidence—that is to say to direct light into the interior. The lower and upper slats are able to be produced inherently approximately symmetrically and thus with low stresses in the reshaping process. The slats become stacked well to form a slat assembly despite different contours on account of the complementary contour zone K. The edge zones in the case of the overlying slats are intelligently positioned very slightly upwards like wings in order, firstly, not to encroach on the cross-sectional contour of the bottom slats, and to enable the stackability, and in order, secondly, to form a second reflection focus towards the interior for obtaining zenith light.

The contour thus enables an intelligent energy and light distribution inwards and/or outwards and thus a precise configuration of the light and energy transmission of a window. Furthermore, precise, directional light directing into the interior depth is achieved, particularly for the zenith radiation. Above the level of a user's eyes from the window region zenith light is directed shallowly to horizontally into large interior depths and provides for uniform interior illumination, without subjecting the user to glare.

### BRIEF DESCRIPTION OF THE DRAWINGS

In the figures:

FIG. 1 shows bifocal slats for the upper light region of a window.

FIG. 2 shows monofocal slats for the lower window region.

FIG. 3 shows details of a bifocal slat.

FIG. 4 shows a slat assembly.

FIGS. 5 and 6 show energy transmission diagrams.

FIGS. 7 and 8 show light distribution curves of the slat reflection.

FIG. 9 shows a perspective sectional view through a bifocal slat hanging.

FIG. 10 shows a cross section through an interior with arrangement of the slats in the façade.

FIG. 11 shows a slat with appendages wrapped upwards.

### DETAILED DESCRIPTION OF THE INVENTION

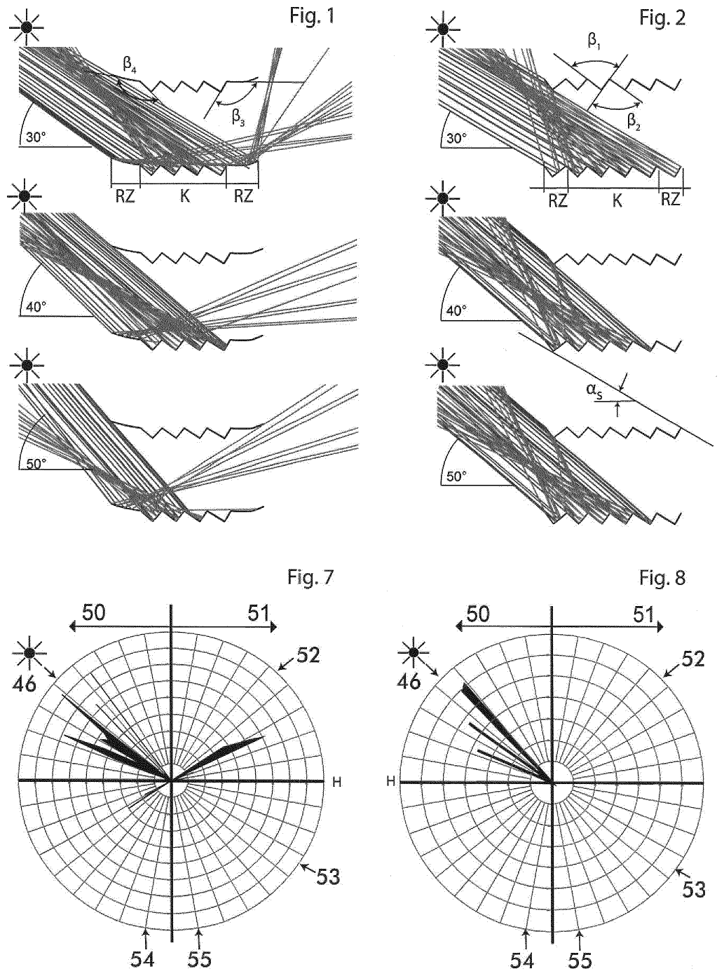

FIGS. 1 and 2 illustrate typical slat contours for the lower window region and the upper window region, which were developed from the standpoint of production, the positively locked slat contour and the stacking in a slat assembly and also the bifocal light directing and freedom from glare. “Bifocal” means that one part of the impinging radiation is directed into the interior in a focusing manner and a further part is directed outwards in a focusing manner. “Deflected inwards” is synonymous with “into the half-space located opposite the half-space of the lateral light incidence”. “Deflected outwards” is synonymous with a reflection back into the half-space of the lateral light incidence. “Lateral light incidence” should be understood to mean a light incidence from the upper half-space—that is to say from the direction of the sky—preferably with large elevation angles. The term “light deflection” is synonymous with light reflections, wherein “light deflection” should also be understood to mean a plurality of reflections.

The slats in FIGS. 1 and 2 are characterized by a shape-complementary contour zone K having fold angles β₁ at the underside and β₂ at the top side of the slats, which are designed to be >70°<110°, preferably approximately 90°. The overlying slat in FIG. 1 has fold angles β₃ and β₄>120° in the edge zone RZ at the top side, such that the edge zones RZ project like wing elements and the light reflection is deflectable into the half space opposite the half-space of the sunlight incidence—that is to say into an interior in the installed state.

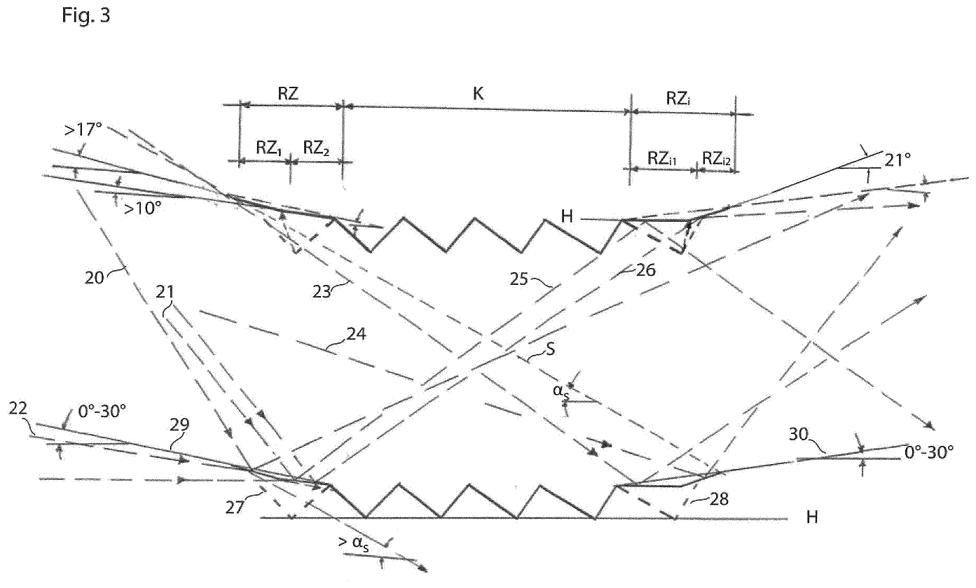

In a roller set, firstly the profile for the upper light region (FIG. 1) is produced. Only in the course of further passes does the basic profile arise (FIG. 2), by virtue of the edge zone RZ being shaped further in an angular fashion, this then resulting in a fold side facing the lateral incidence and a fold side facing away relative to the lateral light. In FIG. 3, in the wings there is a bend in the edge zones, said bend, in terms of its position, preparing the approximately right-angled shaping of the basic profile and simultaneously stiffening and stabilizing the edge zones. The figures show the reflection behaviour of the slats in a horizontal slat position for 30°, 40° and 50° sun incidence.

In FIG. 3, the edge zones RZ are embodied as two bent or curved segments RZ₁ and RZ₂. In the present case, the bend on the irradiation side is 7°, for example, such that the slats RZ₁ are inclined by 17° to 30° and the segment RZ₂ by 10° to 26° with respect to the horizontal. These angles ensure that the high sunlight 20, 21 at the top side is deflectable between the slats into the interior depth and very shallow sunlight 22 impinging on the underside of RZ₁ is deflectable onto the top side of the lower slat.

Sunlight 23 at angles >αₛ—the inclination angle of the shadow line S—or else sunlight 24<αₛ is deflected at the top side of RZᵢ, to the interior ceiling.

The edge zone RZᵢ, located towards the interior is embodied likewise in a bent fashion purely by way of example, the slat edge RZᵢ₂ having an angle of min. 20°. Reflected solar radiation 25 that is incident on the segment RZᵢ₁ from below is deflected >0° into the interior depth without producing glare. The first segment RZᵢ₁ is advantageously designed to be <0° in order that the reflected radiation 25 is not deflected shallowly into the user's eye in the interior, but rather steeply downwards to the floor plane. Deflected solar radiation 26 impinges on segment RZᵢ₂ and is deflected to the interior ceiling and into the interior depth.

The slat shapings illustrated here should be considered particularly in the case of slat surfaces which on both sides are specularly reflective or are at least metallically reflective or lacquered with high gloss, even though the innovation is not restricted thereto. A coloured or matt white slat underside also belongs to the scope of protection of the invention. In this case, freeform shapes developed primarily from the standpoint of light deflection at the slat top sides can also be chosen for the edge zones RZ. The innovative, optimized slat contour determination ensures, even in the case of a white lustrous underside, that glare does not occur since even a white surface impinged on by sunlight produces a high degree of glare.

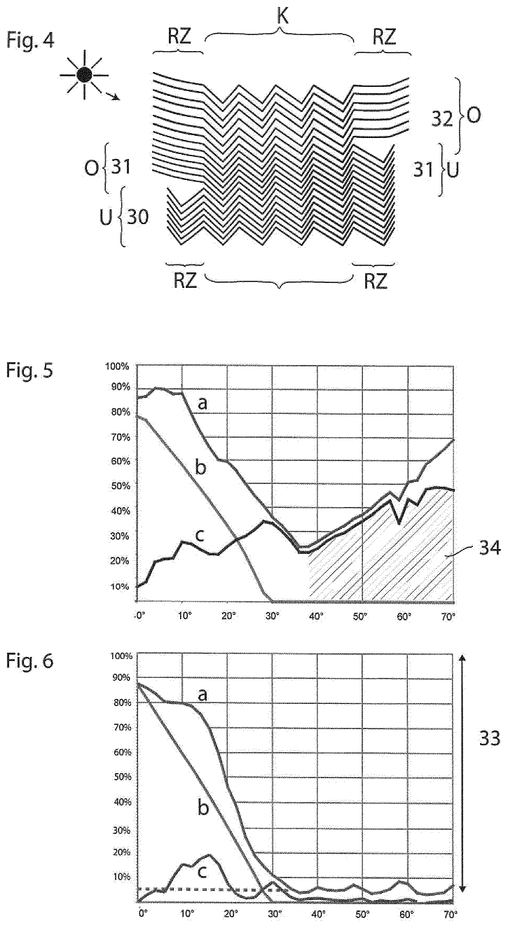

The advantage of the slat configuration for a blind hanging is that the different slats in FIG. 4 can be fitted together. In particular, the slats can be shaped using an identical roller tool. It is only starting from a specific pass starting from which the outer folds are shaped in the edge zones RZ that further roller set pairs are used to shape the slats for the lower window region. This shaping exhibits the dashed contour 27 and 28.

FIGS. 1 and 2 show the optical behaviour of the slats in the case of light incidence of 30°, 40° and 50°. The slat for the lower window region (FIG. 2) directs light out monofocally, the slat for the upper window region is bifocal, i.e. the core zone K directs light out, and the edge zones RZ direct light in. The sunlight is illustrated in each case as a parallel beam of rays, and the reflected light as focusing beams of rays.

The edge zones RZ of the bifocal slats in FIGS. 1, 2, 3, 7 are angled in each case such that in a further shaping with respect to the basic slat the bend points of the folds are prepared by incipient bending (FIG. 3). This is an advantageous variant. Other shapings from the standpoint of particular light guidance with displaced bend points or as a plane or as concave curvature are possible. It is advantageous to incline chords 30 at the slat edge zones RZ facing the lateral light at angles of 0°-30° and chords 31 on the edge zone RZᵢ, facing away from the lateral light at an angle of 0°-30°. All angle indications relate to a horizontal slat position H. In a blind hanging the slats can also be tilted in order e.g. to mask out or to shade shallow sunlight.

FIG. 4 shows three slat types. The bottommost and middle slats 30, 31 and also the middle and upper slats 30, 32 fit together in a positively locking manner. The middle slats exhibit only an edge zone RZ embodied in an extended fashion on the longitudinal edge located towards the lateral light incidence. The present slat assembly could produce a hanging zoned in a tripartite fashion, which realizes a differentiated total energy and light transmission within the hanging.

FIGS. 7 and 8 show the light distribution at the slats from FIGS. 1 and 2 of 50° light incidence into the half-spaces 50 and 51. The illustrations respectively show the light distribution into the upper half-space 52 of the lateral light incidence 46 and into the upper half-space 52 opposite the lateral light incidence. FIG. 7 shows the bifocal property of the light deflection into the half-space 50 and 51, while FIG. 8 shows the monofocal light reflection back into the half-space 50. A light deflection into the lower half-space 53 is largely avoided.

FIGS. 5 and 6 show the transmission behaviour between two slats from FIG. 1 and FIG. 2, respectively, into the half-space opposite the half-space of the light incidence—that is to say into an interior. The angles of incidence of sunlight are depicted on the abscissa, and the light transmission in percent on the ordinate. The directing of light into an interior by the slats from FIG. 1 is evident in FIG. 5 in comparison with the table in FIG. 6 from the increased energy or light irradiation at angles of incidence of between 40° and 70°. The more the lateral light irradiation approaches the zenith, the greater the light transmission into the opposite half-space or into the interior.

Curves a show the total light and energy transmission (absorption plus direct insolation including reflected radiation) as a function of the lateral light incidence. Curves b show proportionally the directly incident radiation between the slats and curves c show proportionally the light reflected at the edge zones RZ including diffuse radiation portions owing to edge roundings at the fold vertices. With a slat from FIG. 2, a very good reduction 33 in FIG. 6 can be achieved for the high direct sunlight in summer. The dashed region 34 in FIG. 5 shows the gain for zenith radiation by way of the edge zones RZ in FIG. 1 The sizes of the hanging zones with slats in accordance with FIGS. 1 and 2 are dimensioned depending on degree of latitude, sky direction, local climate, etc.

FIG. 10 shows a perspective illustration of further slats similar to the slats from FIGS. 1 and 2, but with a smaller contour zone K with only two folds. The slats can have any desired number of folds, but at least three folds on the slat top side of the slats in the lower window region and one fold in the upper window region. The slats in FIG. 10 for the lower window region have a first and respectively a last shaded fold side 40, 41. The edge zones 42, 43 of the upper slats are impinged on by sunlight, without forming a shaded fold side—at least not for relatively steep angles of incidence of sunlight. In this respect, the term “lateral light” should be understood primarily to mean radiation from the upper half-space distinctly above the horizon.

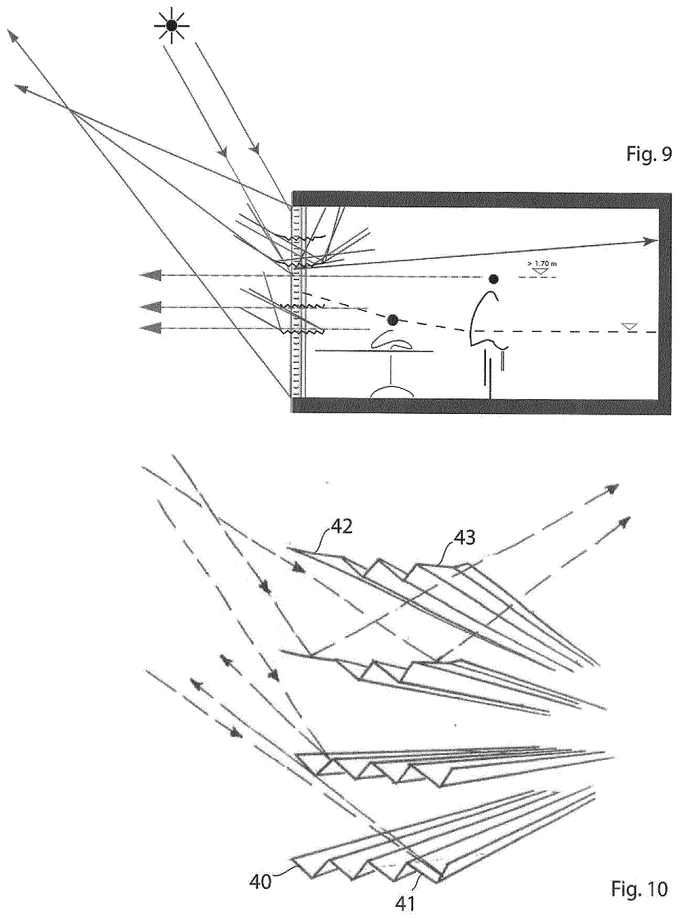

A typical application of the slats in FIGS. 1 and 2 is shown in FIG. 9. Above eye height—that is to say starting approximately from 1.70 m—a change of the slat types takes place. The lower window region directs light out monofocally and suppresses glare; the upper window region is bifocal with directing in of zenith light and also such that it directs in shallower sunlight into the interior depth. By way of the zoning in the hanging or by way of the number of individual slat types, it is possible to design an exact determination of the total energy transmission and light transmission and thus by way of the room illumination profile right into the room depth by means of the transmission diagrams in FIGS. 5 and 6 and also the light distribution curves from FIGS. 7 and 8.

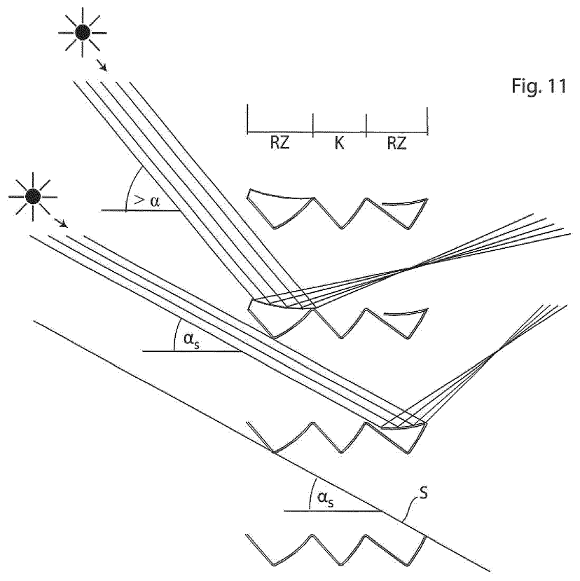

FIG. 11 shows a further slat configuration by virtue of the fact that, from a monofocal base slat for the lower window region, a bifocal slat for the upper window region is produced by means of wrapped appendages 12, 13. By means of the appendages, the optical system is superimposed on the base slat. Production is carried out by means of a common roller tool for the base profile and the base profile is overlapped by the appendages 12, 13 in downstream tools. The advantage is that no tool change is required. Only the feed-in width of the flat strip changes depending on the desired contour.

On no account should the term “focus” or “focusing” be understood in a restrictive way as a punctiform collection of reflections. It merely clarifies that individual reflections cross one another and many reflections form a focusing zone.

The following listing discloses several embodiments of the invention.

### Paragraph 1

Stackable slats for directing light as a preliminary product for blind sun protection hangings for directing light, comprising slats having metallic reflector lustre at least at the slat top sides, wherein
the slats are folded at least partly angularly in the longitudinal direction and an upper fold angle b₂ and a lower fold angle bᵢ between the folds arise in a horizontal slat position, wherein
at least one portion of the folds has in each case a lateral light irradiation side and a lateral light shadow side, such that on account of the inclination angles of the fold sides at least one lateral light irradiation side in the installation state faces incident sunlight and a lateral light shadow side faces away relative to the lateral light from the upper half space and is angled at the angle b−i, and wherein
at least two slats lying one on top of another at least partly have a fold-shaped contour zone K, in which the slats are able to be placed one on top of another shape-complementarily and have at least one edge zone RZ,
characterized in that
   an upper slat lying on a bottom slat in the installation state at least in an edge zone RZ on the lateral light incidence side has at least one larger fold angle b₃ and/or b₄ relative to the contour zone K, and is embodied such that it is bent and/or curved and/or extended in the longitudinal direction and is embodied without a fold side facing away from the light vis-a-vis very high light incidence, such that
   at least one edge zone RZ of a top slat is shaped differently from an edge zone RZ of a bottom slat, wherein
   the edge zone contour RZ of the overlying slat does not penetrate through the edge zone RZ of the bottom slat contour, and
   the edge zone RZ of the top slat has no area portions from the upper half-space that face away vis-a-vis relatively high lateral light incidence, such that
   the slats are stackable in a blind assembly despite different cross-sectional contours in the edge zones RZ of the top and bottom slats, wherein
   in the region of the contour zone K of the top and bottom slat types at the lateral light incidence sides, lateral light is able to be reflected back in the direction of that half space from which the lateral light is incident, and that
   at the upper slat lateral light is deflectable at least partly at an edge zone RZ in the direction of that half-space which is opposite the half-space of the lateral light incidence, and that
   at the bottom slat lateral light at least in the edge zone RZ on the lateral light incidence side is able to be reflected back into the half-space from which the lateral light is incident, such that
   with the slat preliminary products bifocal blind sun protection hangings are producible, by means of which in the lower hanging region through the bottom slats lateral light is reflected back substantially into the half-space of the light incidence and in the upper region of the blind sun protection hanging through the overlying slats lateral light with high angles of incidence from the sun is able to be reflected at least partly into the half-space opposite the lateral light incidence and is able to be reflected back into the half-space of the light incidence by way of the shape-complementary contour zone K.

### Paragraph 2

Slats according to Paragraph 1, characterized in that the edge zones RZ of the overlying slats have a fold angle β₃/β₄ that is >β₂ the fold angle in the contour zone K, such that the contours of the edge zone RZ of the overlying slat form self-supporting wing elements which serve as light reflectors and form a reflection focus on the half-space opposite the half-space of the light incidence.

### Paragraph 3

Slats according to Paragraph 1, characterized in that the top slats in the edge zone RZ are extended and/or curved and/or bent or formed by appendages wrapped onto the profile top side.

### Paragraph 4

Slats according to Paragraph 1, characterized in that the slat edge RZ₁ of a top slat with respect to the lateral light incidence side in terms of their angle inclination with respect to the horizontal is arranged so steeply that shallow sunlight (23) incident on the underside of the slat edge RZ, is able to be reflected substantially onto the top side of the lower slat at an angle >αₛ, the angle of the shadow line between an upper slat and a lower slat.

### Paragraph 5

Light-directing slats according to Paragraph 1, characterized in that the edge zone RZᵢ located in the half-space opposite the lateral light incidence is embodied in a bent fashion, such that reflected sunlight (25) impinging from below is able to be reflected at a first segment RZᵢ₁ onto the floor plane and reflected lateral light (26) is able to be reflected onto a second segment RZᵢ₂>0° into the interior.

### Paragraph 6

Slats according to Paragraph 1, characterized in that chords between slat edges in the edge zone RZ at the lateral light incidence side in the envisaged operating state are formed at angles of at least 0° to 30° with respect to the horizontal, such that high lateral light incidence angles between the slats are deflectable into the half-space opposite the lateral light incidence.

### Paragraph 7

Slats according to Paragraph 1, characterized in that chords of the slat edges RZ on the interior side I are inclined by 0° to 30° with respect to the horizontal and shallowly incident lateral light at a shallow angle with respect to the horizontal, in particular of 0° to 90°, is deflectable into the half-space opposite the lateral light incidence.

### Paragraph 8

Light-directing slats according to Paragraph 1, characterized in that at least one fold at the slat edges RZ on the lateral light irradiation side and/or on the side facing away from the lateral light incidence is at least partly covered by appendages (12, 13) wrapped upwards, and in that lateral light impinging on the latter is at least partly deflectable into the half-space opposite the lateral light incidence, such that a bifocal light deflection arises, wherein each of the appendages (12, 13) produces a focus.

### Paragraph 9

Slats according to Paragraphs 1 to 3, characterized in that at least the bottommost slat for an upper window region (32) can be inserted into at least the topmost slat in the lower window region (30), wherein in particular the slats for an upper window region (32) and/or the slats for a lower window region (30) can be combined in each case to form a slat assembly, wherein particularly preferably all slats are able to be combined to form a slat assembly.

### Paragraph 10

Window hanging consisting of a multiplicity of slats according to any of Paragraphs 1 to 9 having light-reflecting slat top sides, wherein the slats have a fold structure (K) in cross section and the window hangings comprise at least two slat types having different contours for an upper window region and a lower window region,
characterized in that
   the slats for the upper window region and for the lower window region have a folded contour K at least in the slat cross-sectional centre, and
   the slats in the upper window region on the lateral light incidence side and/or on the side of the half-space opposite the lateral light incidence have different contours in the edge zones RZ, which are embodied such that
   the slats are stackable and
   in the upper window region only the insolation incident in the contour zone K is deflectable back into the upper half-space on the side of this lateral radiation incidence and lateral radiation incident on the slat edge zones RZ is deflectable at least partly in the direction of the half-space opposite the lateral light incidence, such that
in particular zenith radiation is deflectable via a section of the window hangings that is provided for an upper light region into the half-space opposite the lateral light incidence.

1. Stackable slats for directing light as a preliminary product for blind sun protection hangings for directing light, comprising slats having metallic reflector lustre at least at the slat top sides, wherein
the slats are folded at least partly angularly in the longitudinal direction and an upper fold angle β₂ and a lower fold angle β₂ between the folds arise in a horizontal slat position, wherein
at least one portion of the folds has in each case a lateral light irradiation side and a lateral light shadow side, such that on account of the inclination angles of the fold sides at least one lateral light irradiation side in the installation state faces incident sunlight and a lateral light shadow side faces away relative to the lateral light from the upper half space and is angled at the angle β₁, and wherein
at least two slats lying one on top of another at least partly have a fold-shaped contour zone K, in which the slats are able to be placed one on top of another shape-complementarily and have at least one edge zone RZ,
characterized in that
an upper slat lying on a bottom slat in the installation state at least in an edge zone RZ on the lateral light incidence side has at least one larger fold angle β₃ and/or β₄ relative to the contour zone K, and is embodied such that it is bent and/or curved and/or extended in the longitudinal direction and is embodied without a fold side facing away from the light vis-a-vis very high light incidence, such that
at least one edge zone RZ of a top slat is shaped differently from an edge zone RZ of a bottom slat, wherein
the edge zone contour RZ of the overlying slat does not penetrate through the edge zone RZ of the bottom slat contour, and
the edge zone RZ of the top slat has no area portions from the upper half-space that face away vis-a-vis relatively high lateral light incidence, such that
the slats are stackable in a blind assembly despite different cross-sectional contours in the edge zones RZ of the top and bottom slats, wherein
in the region of the contour zone K of the top and bottom slat types at the lateral light incidence sides, lateral light is able to be reflected back in the direction of that half space from which the lateral light is incident, and that
at the upper slat lateral light is deflectable at least partly at an edge zone RZ in the direction of that half-space which is opposite the half-space of the lateral light incidence, and that
at the bottom slat lateral light at least in the edge zone RZ on the lateral light incidence side is able to be reflected back into the half-space from which the lateral light is incident, such that
with the slat preliminary products bifocal blind sun protection hangings are producible, by means of which in the lower hanging region through the bottom slats lateral light is reflected back substantially into the half-space of the light incidence and in the upper region of the blind sun protection hanging through the overlying slats lateral light with high angles of incidence from the sun is able to be reflected at least partly into the half-space opposite the lateral light incidence and is able to be reflected back into the half-space of the light incidence by way of the shape-complementary contour zone K.

2. Stackable slats according to claim 1, characterized in that the edge zones RZ of the overlying slats have a fold angle β₃/β₄ that is >β₂ the fold angle in the contour zone K, such that the contours of the edge zone RZ of the overlying slat form self-supporting wing elements which serve as light reflectors and form a reflection focus on the half-space opposite the half-space of the light incidence.

3. Stackable slats according to claim 1, characterized in that the top slats in the edge zone RZ are extended and/or curved and/or bent or formed by appendages wrapped onto the profile top side.

4. Stackable slats according to claim 1, characterized in that the slat edge RZ₁ of a top slat with respect to the lateral light incidence side in terms of their angle inclination with respect to the horizontal is arranged so steeply that shallow sunlight (23) incident on the underside of the slat edge RZ, is able to be reflected substantially onto the top side of the lower slat at an angle >αₛ, the angle of the shadow line between an upper slat and a lower slat.

5. Stackable slats according to claim 1, characterized in that the edge zone RZᵢ located in the half-space opposite the lateral light incidence is embodied in a bent fashion, such that reflected sunlight (25) impinging from below is able to be reflected at a first segment RZᵢ₁ onto the floor plane and reflected lateral light (26) is able to be reflected onto a second segment RZᵢ₂>0° into the interior.

6. Stackable slats according to claim 1, characterized in that chords between slat edges in the edge zone RZ at the lateral light incidence side in the envisaged operating state are formed at angles of at least 0° to 30° with respect to the horizontal, such that high lateral light incidence angles between the slats are deflectable into the half-space opposite the lateral light incidence.

7. Stackable slats according to claim 1, characterized in that chords of the slat edges RZ on the interior side I are inclined by 0° to 30° with respect to the horizontal and shallowly incident lateral light at a shallow angle with respect to the horizontal, in particular of 0° to 90°, is deflectable into the half-space opposite the lateral light incidence.

8. Stackable slats according to claim 1, characterized in that at least one fold at the slat edges RZ on the lateral light irradiation side and/or on the side facing away from the lateral light incidence is at least partly covered by appendages (12, 13) wrapped upwards, and in that lateral light impinging on the latter is at least partly deflectable into the half-space opposite the lateral light incidence, such that a bifocal light deflection arises, wherein each of the appendages (12, 13) produces a focus.

9. Stackable slats according to claim 1, characterized in that at least the bottommost slat for an upper window region (32) can be inserted into at least the topmost slat in the lower window region (30), wherein in particular the slats for an upper window region (32) and/or the slats for a lower window region (30) can be combined in each case to form a
slat assembly, wherein particularly preferably all slats are able to be combined to form a slat assembly.

10. Window hanging consisting of a multiplicity of slats according to claim 1 having light-reflecting slat top sides, wherein the slats have a fold structure (K) in cross section and the window hangings comprise at least two slat types having different contours for an upper window region and a lower window region,
characterized in that
the slats for the upper window region and for the lower window region have a folded contour K at least in the slat cross-sectional centre, and
the slats in the upper window region on the lateral light incidence side and/or on the side of the half-space opposite the lateral light incidence have different contours in the edge zones RZ, which are embodied such that
the slats are stackable and
in the upper window region only the insolation incident in the contour zone K is deflectable back into the upper half-space on the side of this lateral radiation incidence and lateral radiation incident on the slat edge zones RZ is deflectable at least partly in the direction of the half-space opposite the lateral light incidence, such that
in particular zenith radiation is deflectable via a section of the window hangings that is provided for an upper light region into the half-space opposite the lateral light incidence.

11. Stackable slats according to claim 2, characterized in that at least the bottommost slat for an upper window region (32) can be inserted into at least the topmost slat in the lower window region (30), wherein in particular the slats for an upper window region (32) and/or the slats for a lower window region (30) can be combined in each case to form a
slat assembly, wherein particularly preferably all slats are able to be combined to form a slat assembly.

12. Stackable slats according to claim 3, characterized in that at least the bottommost slat for an upper window region (32) can be inserted into at least the topmost slat in the lower window region (30), wherein in particular the slats for an upper window region (32) and/or the slats for a lower window region (30) can be combined in each case to form a
slat assembly, wherein particularly preferably all slats are able to be combined to form a slat assembly.
